(19) United States
(12) Patent Application Publication
(10) Pub. No.: US 2022/0228431 A1
(43) Pub. Date: Jul. 21, 2022

(54) SLAT ANGLE ADJUSTMENT DEVICE FOR WINDOW BLIND

(71) Applicant: SHEEN WORLD TECHNOLOGY CORPORATION, Taichung City (TW)

(72) Inventor: PO-YU CHEN, TAICHUNG CITY (TW)

(21) Appl. No.: 17/154,134

(22) Filed: Jan. 21, 2021

(51) Int. Cl. E06B 9/307; E06B 9/322; E06B 9/06

(52) U.S. Cl. CPC E06B 9/307; E06B 9/0638; E06B 9/322

(57) ABSTRACT

A slat angle adjustment device for a window blind includes a casing, a transmission unit, and a driving rod. The casing has a flange inside. The transmission unit has a first worm shaft and a second worm shaft. The first and second worm shafts are rotatably disposed in the casing and meshed with each other. The driving rod has a flexible wing at an outer surface thereof. When assembled, the driving rod is inserted into the casing through a bottom hole of the casing. During the insertion of the driving rod, the flexible wing is compressed by the flange. Once the flexible wing passes through the flange, the flexible wing is restored and engaged with the flange. By this way, a consumer doesn't adjust repeatedly the assembly angle of the driving rod so as to reduce assembly time and increase assembly convenience.

### BACKGROUND OF THE INVENTION

### 1. Field of the Invention

The present invention relates to window blinds and more particularly, to a slat angle adjustment device for a window blind.

### 2. Description of the Related Art

TW Publication No. 201905314 discloses a detachable slat angle adjustment mechanism that allows a consumer to assemble the second shaft member with the first shaft member by himself/herself after purchase, such that the second shaft member won't be exposed to the outside of the headrail during packaging or delivery, avoiding accidental damage of the second shaft member and prohibiting the second shaft member from damaging the slats.

According to the aforesaid prior art, the first shaft member is hidden in the casing, so the positioning holes can't be seen from the outside, causing the consumer to adjust repeatedly the assembly angle of the second shaft member until the positioning protrusions of the second shaft member are engaged with the positioning holes of the first shaft member. As such, the aforesaid prior art is inconvenient in assembly.

### SUMMARY OF THE INVENTION

It is a primary objective of the present invention to provide a slat angle adjustment device for a window blind, which can increase convenience in assembly.

To attain the above objective, the slat angle adjustment device of the present invention comprises a casing, a transmission unit, and a driving rod. The top end of the casing has two through holes at two opposite sides thereof, and the bottom end of the casing has a bottom hole, a wing accommodation space located above the bottom hole and in communication with the bottom hole, and a flange located between the bottom hole and the wing accommodation space. The transmission unit has a first worm shaft rotatably disposed in the casing and a second worm shaft rotatably disposed in the casing. The first worm shaft is provided with a first shaft portion, a first worm tooth portion formed on the outer surface of the first shaft, portion and located between two end portions of the first shall portion inserted into the through holes of the casing, and a non-circular transmission hole passing axially through the first shaft portion. The second worm shaft is provided with a second shaft portion, a second worm tooth portion formed on the outer surface of the second shaft portion and meshed with the first worm tooth portion of the first worm shaft, and a first assembling portion connected with the bottom end of the second shaft portion. The driving rod has a second assembling portion located in the casing and assembled with the first assembling portion of the second worm shaft, a flexible wing provided with a top end thereof connected with the outer surface of the second assembling portion and located in the wing accommodation space of the casing and engaged with the flange of the casing, and a third shaft portion provided with a top end thereof connected with the bottom end of the second assembling portion. When the driving rod is assembled, the second assembling portion of the driving rod is inserted into the casing through the bottom hole of the casing. During the insertion of the driving rod, the flexible wing is compressed by the flange. Once the flexible wing passes through the flange, the flexible wing is restored and engaged with the flange, and simultaneously, the second assembling portion of the driving rod is assembled with the first assembling portion of the second worm shaft. By this way, the assembly of the driving rod is completed.

It can be understood from the above illustration that the slat angle adjustment device of the present invention allows a consumer not to adjust repeatedly the assembly angle of the driving rod, thereby reducing assembly time and increasing assembly convenience.

Preferably, when the flexible wing is compressed by the flange, a part of the flexible wing is received in a recess of the second assembling portion to avoid mutual interference between the flexible wing and the second assembling portion.

Preferably, the wing accommodation space has a truncated cone cross-section with a diameter decreasing gradually away from the flange.

Preferably, the second worm shaft has a dish portion connected between the second shaft portion and the first assembling portion and inserted into an annular groove of the casing so as to perform convenient assembly of the second worm.

Preferably, the first assembling portion is a polygon post, and the second assembling portion has a polygon hole matched with the polygon post. After the second assembling portion is assembled with the first assembling portion, they aren't be rotated relative to each other, such that the second worm shaft can be driven by the driving rod to rotate.

Preferably, the transmission hole has a semicircular cross-section for insertion of a transmission shaft with a semicircular cross-section, such that the transmission shaft can be driven by the first worm shaft to rotate.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a slat angle adjustment device of the present invention.

FIG. 2 is an exploded perspective view of the slat angle adjustment device of the present invention.

FIG. 3A is a sectional view of the slat angle adjustment device of the present invention, showing the flexible wing is compressed by the flange.

FIG. 3B is similar to FIG. 3A, showing the driving rod is assembled with the second worm shaft.

### DETAILED DESCRIPTION OF THE INVENTION

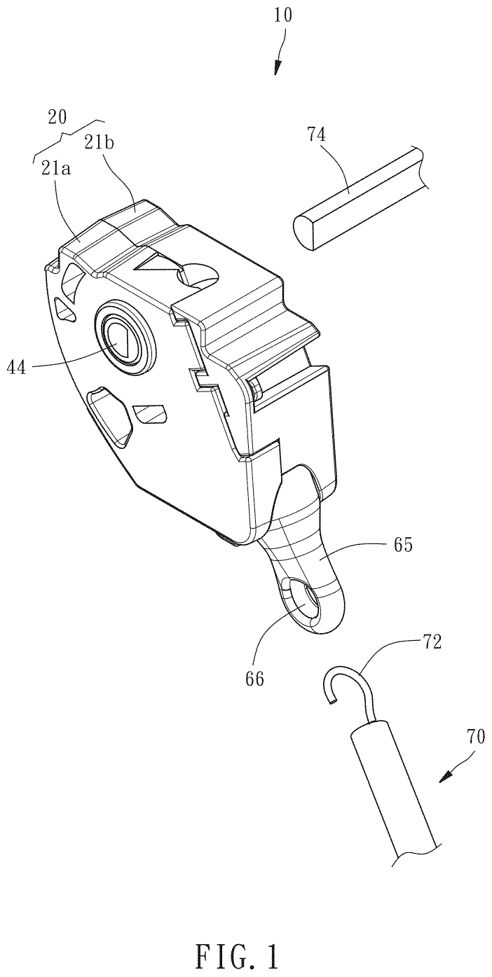

Referring to FIGS. 1, 2 and 3B, a slat angle adjustment device 10 of the present invention comprises a casing 20, a transmission unit 30, and a driving rod 60.

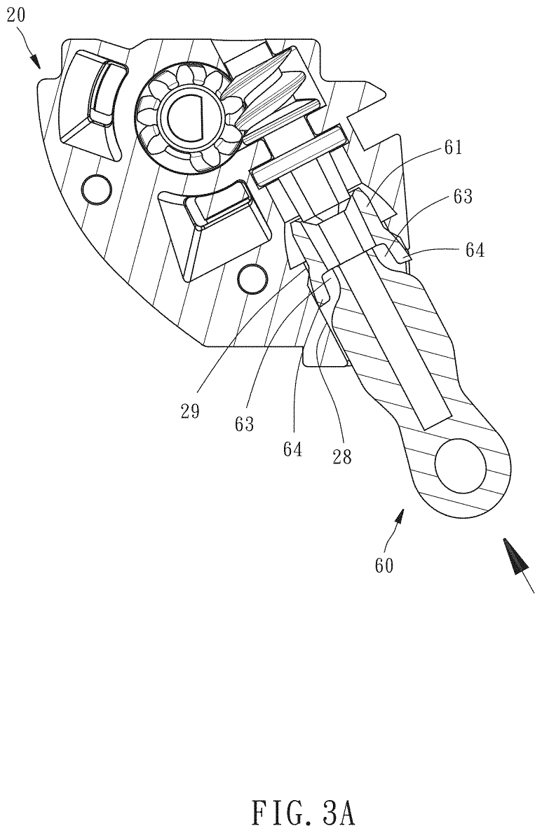

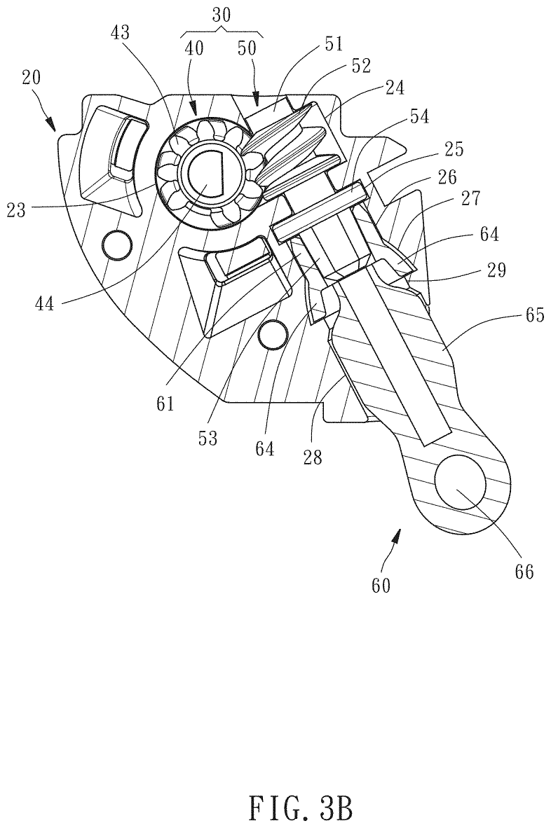

The casing 20 includes two half shells 21a, 21b fastened together. A through hole 22 is provided at each of left and right sides of the top end of the casing 20. The two through holes 22 are communicated with each other through a first accommodation space 23. Further, the casing 20 has a second accommodation space 24 at one side of the first accommodation space 23 and in communicating with the first accommodation space 23. As shown in FIG. 3B, the casing 20 has an annular groove 25 located under the second accommodation space 24, a receiving hole 26 in communicating with the annular groove 25, a wing accommodation space 27 in communicating with the receiving hole 26, and a bottom hole 28 in communicating with the wing accommodation space 27. The wing accommodation space 27 and the bottom hole 28 are divided by a flange 29. The wing accommodation space 27 has a truncated cone cross-section with a diameter decreasing gradually away from the flange 29.

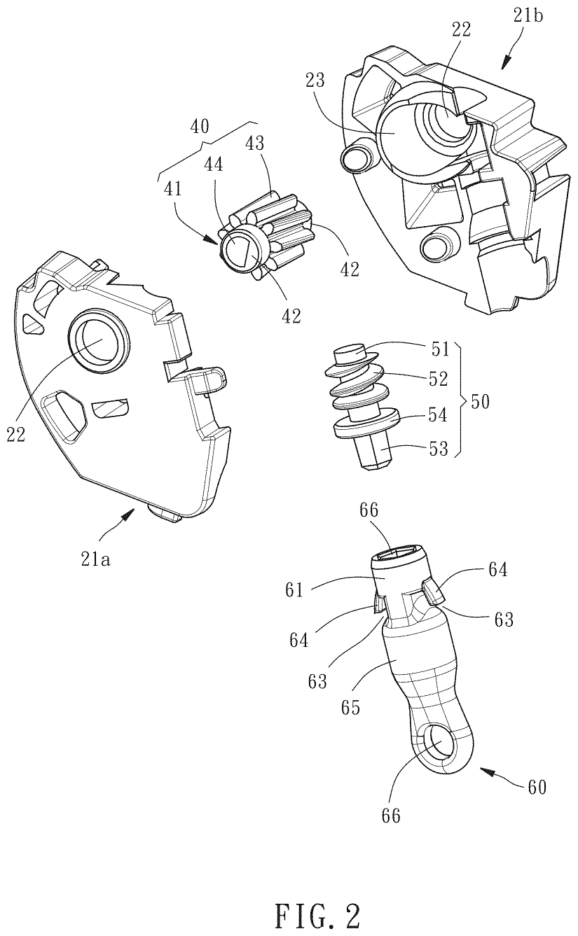

As shown in FIGS. 2 and 3B, the transmission unit 30 has a first worm shaft 40 provided with a first shaft portion 41, a first worm tooth portion 43 formed on the outer surface of the first shaft portion 41 and located between two end portions 42 of the first shaft portion 41, and a non-circular transmission hole 44 (by taking semicircle as an example) passing axially through the first shaft portion 41. The first worm shaft 40 is rotatably disposed in the casing 20 in such manner that the two end portions 42 of the first shaft portion 41 are inserted into the through holes 22 of the casing 20, and the first worm tooth portion 43 are located at the first accommodation space 23 of the casing 20, and the transmission hole 44 is engaged with a transmission shaft 74, which has the same cross-section as the transmission hole 44 (as shown in FIG. 1).

As shown in FIGS. 2 and 3B, the transmission unit 30 further has a second worm shaft 50 provided with a second shaft portion 51, a second worm tooth portion 52 formed on the outer surface of the second shaft portion 51, and a first assembling portion 53 (by taking a polygon post as an example) connected with the bottom end of the second shaft portion 51 through a dish portion 54. The second worm shaft 50 is rotatably disposed in the casing 20 in such a manner that the second worm tooth portion 52 and the first assembling portion 53 are respectively located at the second accommodation space 24 and the receiving hole 26, and the dish portion 54 is inserted in the annular portion 25, and the second worm tooth portion 52 is engaged with the first worm tooth portion 43 of the first worm shaft 40. By this way, the first worm shaft 40 is driven by the second worm shaft 50 to rotate.

The driving rod 60 includes a second assembling portion 61, two flexible wings 64, and a third shaft portion 65. The second assembling portion 61 has a polygon hole 62. The flexible wings 64 are located at two opposite sides of the second assembling portion 61 and each have a top end thereof connected with the outer surface of the second assembling portion 61. The top end of the third shaft portion 65 is connected with the bottom end of the second assembling portion 61, and the bottom end of the third shaft portion 65 has a hook hole 66. As shown FIGS. 3A and 3B, when assembled, the second assembling portion 61 of the driving rod 60 is inserted in the casing 20 through the bottom hole 28 of the casing 20. During the insertion of the driving rod 60, the flexible wings 64 are compressed by the flange 29. Once the flexible wings 64 pass through the flange 29, the flexible wings 29 are restored and located in the wing accommodation space 27 of the casing 20 and engaged with the flange 29. At the same time, the polygon hole 62 of the second assembling portion 61 are engaged with the first assembling portion 53 of the second worm shaft 50, such that the second worm shaft 50 can be driven by the driving rod 60 to rotate, thereby performing the assembly of the driving rod 60, After the assembly of the driving rod 60, the bottom end of the third shaft portion 65 protrudes from the casing 20. Thus, a hook portion 72 of an adjusting rod 70 can be hooked by a user in the hook hole 65 of driving rod 60 and then the adjusting rod 70 is forced by the user to rotate. During rotation of the driving rod 60, the second worm shaft 50 is driven by the driving rod 60 to rotate the first worm shaft 40, causing rotation of transmission shaft 74 and other coupled transmission component parts (such as rotary drum and ladder cord) and adjustment of the angular position of slats of a window blind (not shown).

It deserves to be mentioned that the second assembling portion 61 is provided with two recesses 63 at a bottom end thereof. As shown FIGS. 2 and 3A, the two recesses 63 are corresponding to the two flexible wings 64 in a one-to-one manner. As such, when the flexible wings 64 are compressed by the flange 29, a part of each of the flexible wings 64 is received in one respective recess 63 to avoid mutual interference between the flexible wings 64 and the second assembling portion 61.

As described above, the first worm shaft 40 and the second worm shaft 50 are mounted inside the casing 20, and the driving rod 60 is a separated component that is assembled with the casing 20 by means of the engagement between the flexible wings 64 and the flange 29, that is to say, the slat angle adjustment device 10 of the present invention allows a consumer to assemble the driving rod 60 with the second worm shaft 50 by himself/herself after purchase, so it is unnecessary for the consumer to adjust repeatedly the assembly angle of the driving rod 60, thereby reducing assembly time and increasing assembly convenience.

What is claimed is:

1. A slat angle adjustment device for a window blind, comprising:
a casing having two opposite through holes, a bottom hole, a wing accommodation space located above the bottom hole and in communication with the bottom hole, and a flange located between the bottom hole and the wing accommodation space;
a transmission unit having a first worm shaft rotatably disposed in the casing and provided with a first shaft portion, a first worm tooth portion formed on an outer surface of the first shaft portion and located between two end portions of the first shaft portion inserted into the through holes of the casing, and a non-circular transmission hole passing axially through the first shaft portion, and a second worm shaft rotatably disposed in the casing and provided with a second shaft portion, a second worm tooth portion formed on an outer surface of the second shaft portion and engaged with the first worm tooth portion of the first worm shaft, and a first assembling portion connected with a bottom end of the second shaft portion; and
a driving rod having a second assembling portion located in the casing and assembled with the first assembling portion of the second worm shaft, a flexible wing provided with a top end thereof connected with an outer surface of the second assembling portion and located in the wing accommodation space of the casing and engaged with the flange of the casing, and a third shaft portion provided with a top end thereof connected with a bottom end of the second assembling portion and inserted into the bottom hole of the casing and having a part exposed to the outside of the casing.

2. The slat angle adjustment device as claimed in claim 1, wherein when the flexible wing is compressed by the flange, a part of the flexible wing is received in a recess of the second assembling portion.

3. The slat angle adjustment device as claimed in claim 1, wherein the wing accommodation space has a truncated cone cross-section with a diameter decreasing gradually away from the flange.

4. The slat angle adjustment device as claimed in claim 1, wherein the second worm shaft has a dish portion connected between the second shaft portion and the first assembling portion and inserted into an annular groove of the casing.

5. The slat angle adjustment device as claimed in claim 1, wherein the first assembling portion is a polygon post, and the second assembling portion has a polygon hole engaged with the polygon post

6. The slat angle adjustment device as claimed in claim 1, wherein the transmission hole has a semicircular cross-section.
